(19) United States
(12) Patent Application Publication
(10) Pub. No.: US 2014/0207695 A1
(43) Pub. Date: Jul. 24, 2014

(54) Social Network-Based Fundraising System and Method Thereof

(71) Applicants: Jonathan Beekman, Palo Alto, CA (US); Bryan Treglia, Chandler, AZ (US)

(72) Inventors: Jonathan Beekman, Palo Alto, CA (US); Bryan Treglia, Chandler, AZ (US)

(21) Appl. No.: 13/748,592

(22) Filed: Jan. 24, 2013

(51) Int. Cl. G06Q 40/00; G06Q 50/00

(52) U.S. Cl. CPC G06Q 40/00; G06Q 50/01
USPC 705/319

(57) ABSTRACT

A processor implemented method comprising receiving, from a first coordinator, contact information for each of a first set of potential contributors and creating a first fundraising group. The method further comprises facilitating a payment of a contribution from at least one member of the first fundraising group to a fundraising entity and receiving contact information for each of a second set of potential contributors. The second set of potential contributors is provided by a second coordinator, wherein the second coordinator is included in the first fundraising group, and/or at least one of the second set of potential contributors in response to an invitation from the second coordinator, and creating a second fundraising group. The method further comprises facilitating a payment of a contribution from at least one member of the second fundraising group to the fundraising entity.

### TECHNICAL FIELD

The present invention relates to a system and method for fundraising by leveraging existing social groups, and more particularly to a web-based social network-based fundraising system and method, and most particularly to a multi-level social network-based fundraising system and method.

### BACKGROUND ART

Fundraising activities are undertaken by a number of organizations, including charities, schools, sports clubs, hospitals, legal associations, and non-profit corporations. In many instances, fundraising is vital to the continued existence of many of these organizations. These organizations employ a wide variety of fundraising techniques. Example of such techniques include group fundraising activities, such as dinners, “casino nights”, or other type of in-person activity. Other involve in-person solicitations, such as door-to-door fundraising, booths at public events or in front of retail stores. Yet, others involve electronic communications, such as email or social networking sites, such as Facebook, Twitter, or LinkedIn. In nearly all cases, the solicitation of funds resembles a hub and spoke model, where the fundraising entity (i.e., the hub), whether the organization itself or volunteers working closely with and on behalf of the organization, reach out directly to potential donors (i.e., the spokes).

In many cases, an actual donor (a potential donor who makes a contribution) may share a passion for the fundraising purpose and wish to assist in the fundraising effort. But, this currently requires the donor to volunteer with the organization and/or become a de-factor member of the organization. In many cases, this is time prohibitive and/or requires a level of commitment that the donor cannot meet, in spite of their passion for the cause.

In addition, a number of factors prevent potential donors from becoming actual donors. For example, the potential donor could be financially constrained. But in some cases, the potential donor is financially capable of contributing and would be willing to contribute, but does not contribute due to variety of non-financial barriers. These barriers may include, for example, (i) the hassle of making a contribution, (ii) the timing of a contribution in their financial cycle (ex., they may be reluctant to contribute during the holiday season due to upcoming holiday expenses), (iii) in the case of tax credit eligible contributions, the length of time until they can file their taxes (ex., they may be more reluctant to make a tax credit eligible contribution early in the year if they will not get their refund back until they file their taxes at the end of the year), (iv) their focus on the fundraising purpose (ex: after learning of the fundraising opportunity, they may forget by the time they get home or to a place where they can make the actual contribution), (v) understanding and/or trust in the fundraising purpose (i.e., will the contributions they give actually go to the stated fundraising purpose?). Current fundraising techniques do little, if anything to address these concerns outside of improving their communication or marketing message.

Furthermore, many states offer incentives in the form of state tax credits for qualifying donations to certain fundraising entities. In some cases, the tax credits are for a portion of the contribution amount. For example, for a $1000 contribution eligible for a 50% tax credit, the donor would have their tax liability reduced by $500 (i.e., 50% of the contribution amount). In this case, the donor was able to direct $1000 to a cause they support for a cost of only $500. Some states even offer 100% tax credits for some types of contributions. The financial burden on donors in these cases is reduced, or even eliminated. If the other non-financial barriers that donors encounter could be reduced or eliminated, a drastic increase in fundraising collections would be expected.

While fundraising entities often thank their contributors for their support, very few, if any, provide a mechanism for the beneficiaries of the fundraising effort to directly thank the relevant contributor(s) (i.e., those who contributed the funds, property, or services that the beneficiary received). This is likely due to privacy concerns as there are a number of reasons to prevent the contributors from learning the identity of the beneficiary and vice versa. One such reason is due to the fact that 501(c)(3) entities are prohibited from disclosing donor information. However, providing a mechanism for beneficiaries to thank their relevant contributors, while maintaining privacy and adherence to applicable laws, would lead to a increase in the number of repeat contributions.

Accordingly, it would be an advance in the state of the art to provide a system and method to (i) provide to individuals, not directly associated with the fundraising purpose, an effective way to reach out to their social network(s) to further the fundraising purpose, (ii) ease or remove the barriers that prevent potential donors from making contributions, and (iii) provide a mechanism to allow beneficiaries to thank the donors that provided them assistance while maintaining the privacy of each party.

### SUMMARY OF THE INVENTION

A processor implemented method of fundraising is presented. The method comprises receiving, from a first coordinator, contact information for each of a first set of potential contributors and creating a first fundraising group. The first fundraising group comprises a first group portal and membership in the first fundraising group comprises the first set of potential contributors. The method further comprises facilitating a payment of a contribution from at least one member of the first fundraising group to a fundraising entity and receiving contact information for each of a second set of potential contributors. The second set of potential contributors is provided by (i) a second coordinator, wherein the second coordinator is included in the first fundraising group and/or (ii) at least one of the second set of potential contributors in response to an invitation from the second coordinator. The method further comprises creating a second fundraising group. The second fundraising group comprises a second group portal and membership in the second fundraising group comprises the second set of potential contributors. The method further comprises facilitating a payment of a contribution from at least one member of the second fundraising group to the fundraising entity.

A fundraising system is presented. The fundraising system comprises memory and a processor. The processor is in communication with the memory and configured to issue processing instructions stored in the memory to receive, from a first coordinator, contact information for each of a first set of potential contributors, and create a first fundraising group. The first fundraising group comprises a first group portal and membership in the first fundraising group comprises the first set of potential contributors. The processor further issues instructions to facilitate a payment of a contribution from at least one member of the first fundraising group to a fundraising entity; and receive contact information for each of a second set of potential contributors. The second set of potential contributors is provided by a second coordinator, wherein the second coordinator is included in the first fundraising group and/or at least one of the second set of potential contributors in response to an invitation from the second coordinator. The processor further issues instructions to create a second fundraising group. The second fundraising group comprises a second group portal and membership in the second fundraising group comprises the second set of potential contributors. The processor further issues instructions to facilitate a payment of a contribution from at least one member of the second fundraising group to the fundraising entity.

### BRIEF DESCRIPTION OF THE DRAWINGS

The invention will be more fully understood by referring to the following Detailed Description of Specific Embodiments in conjunction with the Drawings, of which:

FIG. 1 is a flowchart of an exemplary computer implemented method for increasing fundraising collections by leveraging social groups;

FIG. 2 is a flowchart of an exemplary computer implemented method for increasing fundraising collections by leveraging social groups through the use of donor pledges;

FIG. 3 is a flowchart of another exemplary computer implemented method for increasing fundraising by leveraging social groups;

FIG. 4 is a diagram illustrating how Applicants' system and method make use of existing social groups to increase donations;

FIG. 5 is a flowchart of an exemplary computer implemented method for increasing fundraising collections through a double-blind communication system;

FIG. 6 is a diagram of the components of the double-blind communication system;

FIG. 7 is an exemplary screenshot of a user interface for a system to increase fundraising collections by leveraging social groups;

FIG. 8 is another exemplary screenshot of a user interface for a system to increase fundraising collection by leveraging social groups;

FIG. 9 is a block diagram illustrating embodiments of Applicants' system; and

FIG. 10 is a functional block diagram illustrating functional component embodiments of Applicants' system.

### DETAILED DESCRIPTION OF SPECIFIC EMBODIMENTS

The invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In certain embodiments, the Applicants' system enables the creation of a web-based, multi-level social network-based fundraising platform. The first level (“Level 1”), involves a coordinator and a fundraising cause. The coordinator is an entity or individual promoting the fundraising cause. The coordinator uses the fundraising platform described herein to reach out to the coordinator's social network. For example, in the case where the coordinator is a school, the school's social network may comprise the parents of the children enrolled in the school. In the case where the coordinator is a youth sports team, the team's social network may be the parents of the team members as well as the friends and other family members who attend the sports events. In the case where the coordinator is a parent, the social network may be the friend, family, and acquaintances of the parent.

The coordinator invites individuals in its social network to become members of the group. In one embodiment, group membership means that an individual has simply been invited to a group. In another embodiment, group membership means that an individual has been invited to a group and has elected to become a member. A individual can explicitly elect to become a member by affirming to such or can implicitly become a member by taking another action, such as making a pledge donation or an actual donation.

The second level (“Level 2”), involves the same fundraising cause as in Level 1 and a second coordinator, where the second coordinator is a member of the Level 1 fundraising group. The second coordinator invites individuals in its social network to become members of the Level 2 group. Considering, for example, the case where the Level 1 coordinator is a school, the fundraising cause is raising money for school scholarships, and the second coordinator is a parent who is a member of the Level 1 group. The parent can invite their friends, family, and acquaintances to the Level 2 group to promote and raise money for the cause of raising money for school scholarships.

Continuing this example, it is unlikely that the parent's friends, family, and acquaintances will have any knowledge or experience with school or the fundraising cause. As such, the solicitation by the school for donations or other contributions from the parent's friends, family, and acquaintances are unlikely to show good results because these potential donors are generally too far removed from the cause and/or entity soliciting donations to be moved to donate.

On the other hand, the social ties between the parent (the second coordinator) and his/her friends, family, and acquaintances (Level 2 group) will generally be much stronger than the social ties between the school (the first coordinator) and the Level 2 group. In short, when solicitations for donations, or other contributions, are made within established social groups, the overall donation level will rise. This process can extend out to any number of groups, where each coordinator (a member of group n−1) creates a group n to promote the fundraising cause.

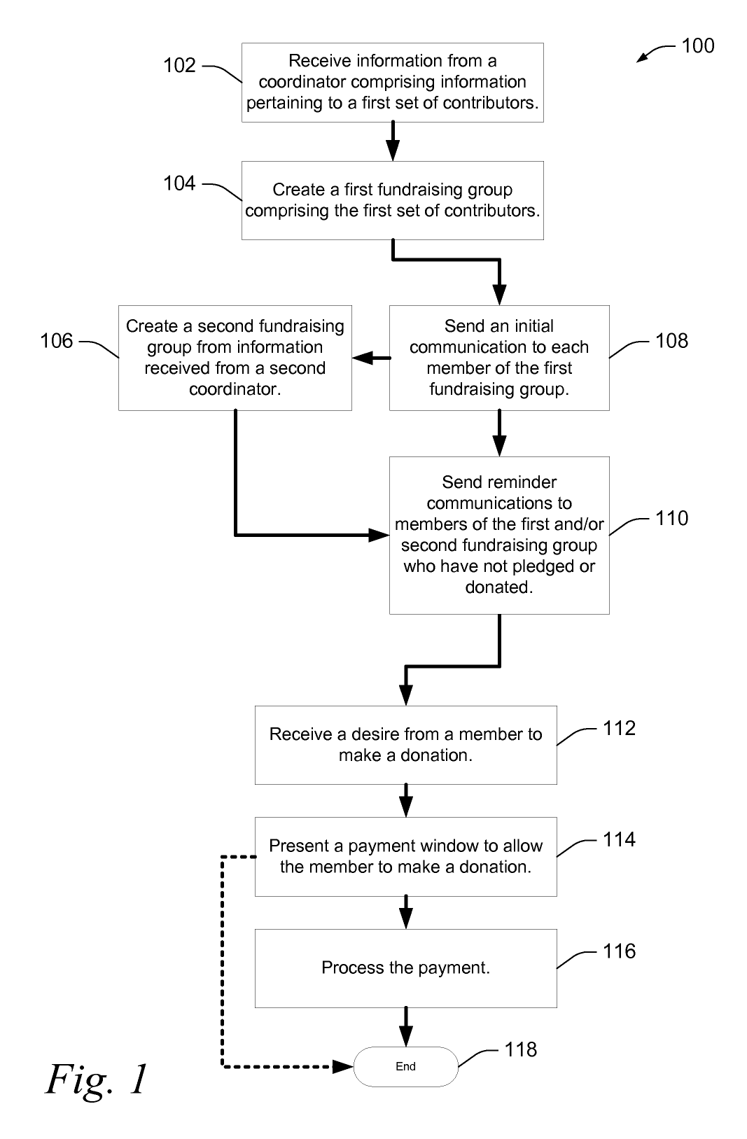

Referring to FIG. 1, a flowchart 100 of an exemplary computer implemented method for increasing fundraising collections by leveraging social groups is depicted. At step 102, the method receives information from a coordinator pertaining to each of a first set of potential contributors.

In one embodiment, the information is receive via email. In one embodiment, the information is received electronically through information entered into a web form.

In one embodiment, the information comprises email addresses of potential contributors. In one embodiment, the information comprises names of the potential contributors. In some embodiments, the information comprises a Level 1 donation goal for the group and/or the deadline for the fundraising effort.

In some embodiments, the information comprises the name of each potential contributor along with supplementary information to be used for a Level 2 group. For example, where the coordinator is a school and each potential contributor is a parent of an enrolled child, this supplementary information may comprise the name of the parent's children who are enrolled in the school and a Level 2 donation goal for the parent. In some embodiments, the Level 2 donation goal is based on the total tuition amount for the parent's enrolled children.

In some embodiments, the information additionally comprises content to customize the donation group, including for example, a personal message, a video, and/or pictures.

At step 104, the method creates a first fundraising group comprising the first set of contributors. In one embodiment, the creation of a fundraising group comprises associating each of the first set of contributors to a new fundraising group and creating a web page (or group portal) for the new fundraising group that is accessible by each of the first set of contributors. Once associated with a donation group, potential contributors are referred to as “members” of the fundraising group.

In one embodiment, the web page for the fundraising group includes the donation goal for the group, the total amount donated by members of the group, a listing of members who have donated, or a combination thereof.

At step 108, the method sends an initial communication to each member of the fundraising group. In one embodiment, the communication comprises an email containing a public link to the fundraising group webpage. In one embodiment, the communication comprises an email containing a private link to the fundraising group webpage. A public link is a link to a website that does not contain any identifying or originating information, where a private link is a link that does contains some type of embedded identifying or originating information. For example, when a recipient of the email clicks on an included public link, the system will not be able to distinguish between a visit to the website from this recipient and any other recipients. In comparison, when a recipient of the email clicks on an included private link, the system will be able to determine that a visit to the site is from the recipient (or someone with access to the recipient's email account). Private links enable the first coordinator to embed information to ease the creation of the second level groups by the second level coordinators.

In various embodiments, the email communication comprises an invitation to be listed as a member of the group, an invitation to make a donation, an invitation to start a new group, or a combination thereof. If the member elects to create a new group, the method transitions to step 106. In the case where a member does not create a new group, the method transitions to step 110.

At step 106, the method creates a second fundraising group from information received from a second coordinator, where the second coordinator is a member of the first fundraising group. In one embodiment, the information comprises email addresses of potential contributors. In one embodiment, the information comprises names of potential contributors. In some embodiments, the information comprises supplemental information as in step 102.

In one embodiment, the second fundraising group is created without receiving any information pertaining to a second set of contributors by the second coordinator. Instead, the group is created upon instructions received by the second coordinator. The instructions may simply be to create a fundraising group or may include other information, such as the donation goal, donation deadline, personal message, and/or photos related to the fundraising cause. Once the group is created, the contributor sends a link to the fundraising group webpage to each potential contributor. A potential contributor will become a member of the second fundraising group by explicitly electing to become a member (i.e., by affirming to such on the fundraising group webpage) or implicitly becoming a member (i.e., by taking another action, such as making an actual donation).

At step 110, the method sends a reminder communication to members of the first and/or second fundraising group to each member who had not made a donation. In various embodiments, the reminder includes the donation goal for the group, the total amount donated by members of the group, a listing of members who have donated, or a combination thereof. In some embodiments, the reminder communication includes content received from the first coordinator, the second coordinator, and/or the fundraising director.

At step 112, the method receives a desire from a member to make a donation. In one embodiment, this desire is manifested by clicking “donate” button on the group webpage or in the initial or reminder communication emails. In one embodiment, the desire is manifested by the receipt of a phone call or postal letter that is entered into the method by an operator.

At step 114, the method presents a payment window to allow the member of the first or second fundraising group to make a donation. In one embodiment, the presentation of a payment window comprises displaying a web form. In one embodiment, the presentation of a payment window comprises issuing instructions to send the member a paper donation form through postal mail.

At step 116, the payment is processed. In various embodiments, the payment is processed through a merchant account by a payment provider or through a bank-to-bank transaction using, for example, routing information or a check image.

In one embodiment, processing the payment comprises (i) receiving reoccurring contribution instructions, comprising, a payment method, account information, payment frequency, and a total contribution amount and (ii) processing a portion of the total contribution amount on a reoccurring basis according to the payment frequency. For example, the reoccurring contribution instructions may instruct that $100 per month be paid from a donors Visa over 10 months, for a total contribution amount of $1,000.

In one embodiment, processing the payment comprises (i) receiving contribution instructions, including for example, a payment method and account information and (ii) executing the contribution instructions. For example, a donor may choose to process a $1000 donation immediately by providing the account information for her Visa card.

In one embodiment, the payment account (i.e., the merchant and business account where monetary contributors process and deposited) is maintained by the directors of the fundraising cause. For example, in the case of a school, the school would maintain the payment account and all contributions made through the payment window would be processed by the school's merchant account (if applicable) and flow directly to a bank account belonging to the school. In this embodiment, the method would skip step 116 and proceed directly to step 118, as indicated by the dashed line. For different embodiments, step 114 as well as the combination of steps 114 & 116 may be interpreted as facilitating the payment of a contribution to a fundraising entity. The method ends at 118.

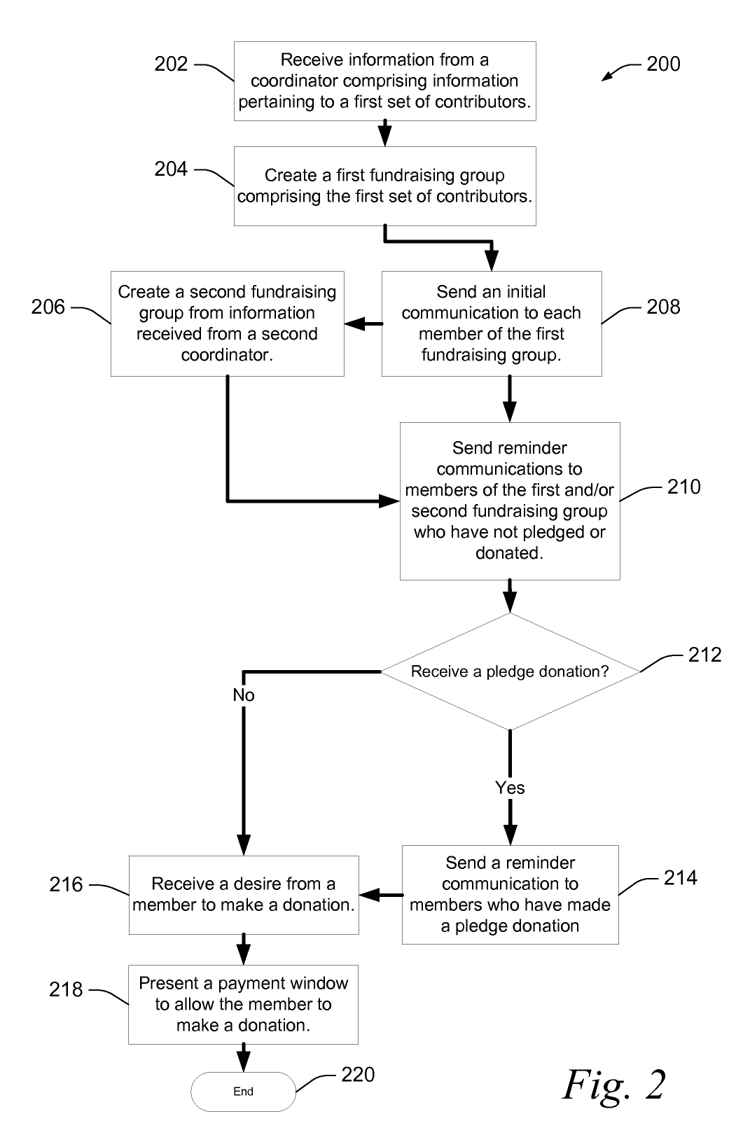

Referring to FIG. 2, a flowchart 200 of an exemplary computer implemented method for increasing fundraising collections by leveraging social groups through the use of donor pledges is depicted. At step 202, the method receives information from a coordinator pertaining to each of a first set of potential contributors.

In one embodiment, the information is receive via email. In one embodiment, the information is received electronically through a web form.

In one embodiment, the information comprises email addresses of potential contributors. In one embodiment, the information comprises names of potential contributors. In some embodiments, the information comprises a Level 1 donation goal for the group and/or the deadline for the fundraising effort.

In some embodiments, the information comprises the name of each potential contributor along with supplementary information to be used for a Level 2 group. In one embodiment where the coordinator is a school and each potential contributor is a parent of an enrolled child, this supplementary information may comprise the name of the parent's children who are enrolled in the school and a Level 2 donation goal for the parent. In some embodiments, the Level 2 donation goal is based on the total tuition amount for the parent's enrolled children.

In some embodiments, the information additionally comprises content to customize the donation group, including for example, a personal message, a video, and/or pictures.

At step 204, the method creates a first fundraising group comprising the first set of contributors. In one embodiment, the creation of a fundraising group comprises associating each of the first set of contributors to a new fundraising group. In one embodiment, the creation of a fundraising group comprises creating a web page for the new fundraising group that is accessible by each of the first set of contributors. Once associated with a donation group, potential contributors are referred to as “members” of the fundraising group.

In one embodiment, the web page for the fundraising group includes the donation goal for the group, the total amount pledged by members of the group, the total amount donated by members of the group, a listing of members who have pledged, a listing of members who have donated, or a combination thereof.

At step 208, the method sends an initial communication to each member of the fundraising group. In one embodiment, the communication comprises an email containing a public link to the fundraising group webpage. In one embodiment, the communication comprises an email containing a private link to the fundraising group webpage. A public link is a link to a website that does not contain any identifying or originating information, where a private link is a link that does contains some type of embedded identifying or originating information. For example, when a recipient of the email clicks on an included public link, the system will not be able to distinguish between a visit to the website from this recipient and any other recipients. In comparison, when a recipient of the email clicks on an included private link, the system will be able to determine that a visit to the site is from the recipient (or someone with access to the recipient's email account). Private links enable the first coordinator to embed information to ease the creation of the second level groups by the second coordinators.

In one embodiment, when a member of the first group makes a pledge donation or actual donation, they will be invited to promote the fundraising cause to their social network by creating a new group. In this case, the method transitions to step 206. In the case where a member does not create a new group, the method transitions to step 210.

At step 206, the method creates a second fundraising group from information received from a second coordinator, where the second coordinator is a member of the first fundraising group. In one embodiment, the information comprises email addresses of potential contributors. In one embodiment, the information comprises names of potential contributors. In some embodiments, the information comprises supplemental information as in step 202.

In one embodiment, the second fundraising group is created without receiving any information pertaining to a second set of contributors (not shown in FIG. 1). Instead, the group is created upon instructions received by the second coordinator. The instructions may simply be to create a fundraising group or may include other information, such as the donation goal, donation deadline, personal message, and/or photos related to the fundraising cause. Once the group is created, the contributor sends a link to the fundraising group webpage to each potential contributor. A potential contributor will become a member of the second fundraising group by explicitly electing to become a member by, for example, affirming to such on the fundraising group webpage or implicitly becoming a member by taking another action, such as making a pledge donation or an actual donation.

At step 210, the method sends a reminder communication to members of the first and/or second fundraising group to each member who had not made a pledge donation or an actual donation. In various embodiments, the reminder includes the donation goal for the group, the total amount pledged by members of the group, the total amount donated by members of the group, a listing of members who have pledged, a listing of members who have donated, or a combination thereof. In some embodiments, the reminder communication includes content received by the first coordinator, the second coordinator, and/or the fundraising director.

At step 212, the method receives a pledge donation. In one embodiment, the pledge is initiated when the member clinks the “pledge” button on the group webpage or in the initial or reminder communication emails. In one embodiment, the pledge is initiated by the receipt of a phone call or postal letter that is entered into the method by an operator. In one embodiment, a pledge donation is made by receiving the email address of the member and the amount pledged.

In one embodiment, a pledge donation comprises receiving a pledge amount and a pledge date. For example, a donor may pledge $1,000 to be processed in 4 months.

In one embodiment, the pledge donation comprises receiving a pledge amount, a pledge date, and payment information. For example, a donor may pledge $1,000 to be processed in 4 months on her credit card (and provide the account information to process payment on her card).

If a pledge is made at step 212, the method transitions to step 214. At step 214, the method sends a reminder communication to members who have made a pledge donation. In various embodiments, the reminder includes a reminder of the pledge, the pledge amount, the donation goal for the group, the total amount pledged by members of the group, the total amount donated by members of the group, a listing of members who have pledged, a listing of members who have donated, or a combination thereof. The method then transitions to step 216.

If a pledge is not made at step 212, the method transitions to step 216. At step 216, the method receives a desire from a member to make a donation. In one embodiment, this desire is manifested by clinking a “donate” button on the group webpage or in the initial or reminder communication emails. In one embodiment, the desire is manifested by the receipt of a phone call or postal letter that is entered into the method by an operator.

At step 218, the method presents a payment window to allow the member (who may be from either the first or second fundraising group) to make a donation. In one embodiment, the presentation of a payment window comprises displaying a web form. In one embodiment, the presentation of a payment window comprises issuing instructions to send the member a paper donation form through postal mail. The method ends at 220.

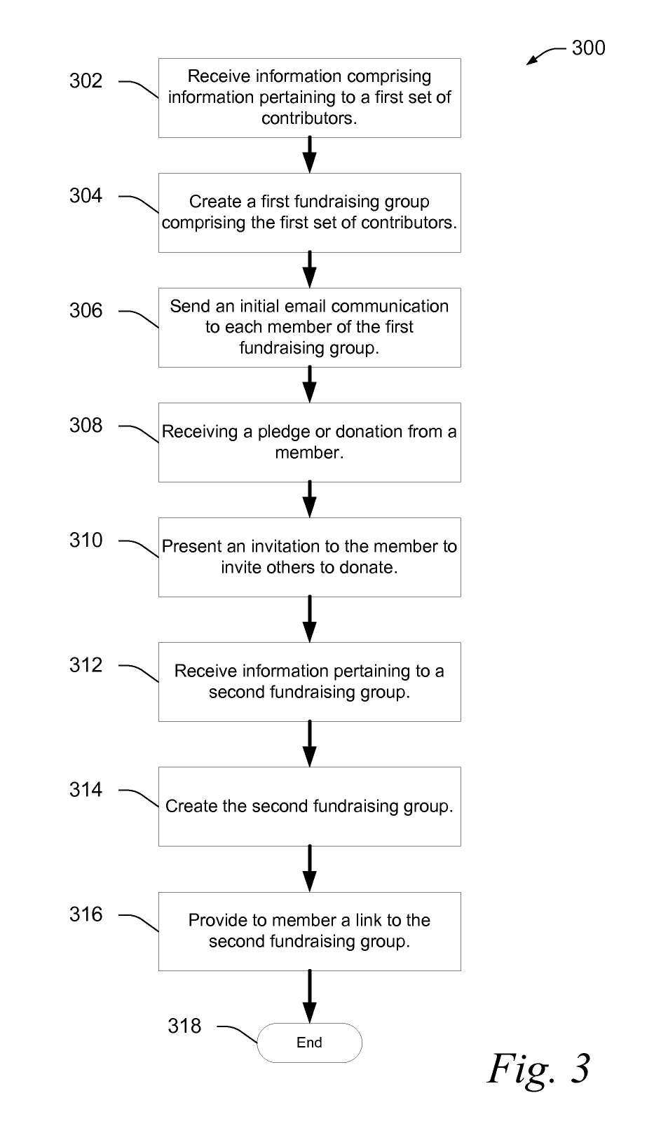

Referring to FIG. 3, a flowchart 300 of another exemplary computer implemented process for increasing fundraising by leveraging social groups is depicted. At step 302, the method receives information comprising information pertaining to a first set of contributors submitted through an online web form. In one embodiment, the information comprises email addresses of potential contributors. In one embodiment, the information comprises names of potential contributors. In some embodiments, the information comprises a donation goal for the group and/or the deadline for the fundraising effort.

In some embodiments, the information comprises the name of each potential contributor along with supplementary information. In one embodiment where the coordinator is a school and each potential contributor is a parent of an enrolled child, this supplementary information may comprise the name of the parent's children who are enrolled in the school and a Level 2 donation goal for the parent. In some embodiments, the Level 2 donation goal is based on the total tuition amount for the parent's enrolled children.

At step 304, the method creates a first fundraising group comprising the first set of contributors. In one embodiment, the creation of a fundraising group comprises associating each of the first set of contributors to a new fundraising group. In one embodiment, the creation of a fundraising group comprises creating a web page for the new fundraising group that is accessible by each of the first set of contributors. Once associated with a donation group, potential contributors are referred to as “members” of the fundraising group.

In one embodiment, the web page for the fundraising group includes the donation goal for the group, the total amount pledged by members of the group, the total amount donated by members of the group, a listing of members who have pledged, a listing of members who have donated, or a combination thereof.

At step 306, the method sends an initial email communication to each member of the fundraising group. In various embodiments, the email communication comprises a invitation to be listed as a member of the group on the group web page, an invitation to make a pledge donation, an invitation to make a donation, an invitation to start a new group, or a combination thereof.

At step 308, the method receives a pledge donation of an actual donation from a member of the first fundraising group. After the pledge donation or actual donation is processed, the method transitions to step 310.

At step 310, the method presents an invitation to the member to promote the fundraising cause by inviting others to donate. In one embodiment, the invitation is presented by causing a solicitation to be displayed on the web page after the pledge donation or actual donation has been entered.

At step 312 and 314, the method receives information from the member pertaining to a second fundraising group and creates the second fundraising group.

In one embodiment, the second fundraising group is created without receiving any information pertaining to a second set of contributors. Instead, the group is created upon instructions received by the second coordinator. The instructions may simply be to create a fundraising group or may include other information, such as the donation goal, donation deadline, personal message, and/or photos related to the fundraising cause.

In one embodiment, the information comprises names and email addresses of potential contributors. The potential contributors are associated with the second fundraising group, and thereby become members of the second fundraising group, and the method sends an initial email communication to each member of the second fundraising group (not shown in FIG. 3).

In one embodiment, the supplementary information provided by the first coordinator is used to create the second fundraising group. For example, referring back to the embodiment in step 302 (where the school is the coordinator), the supplementary information provided by the school, such as names of the enrolled children and donation goal for the parent, are used to configure the second donation group. More specifically, the names are used to customize the group and the tuition amount is used to set the group contribution goal.

At step 316, the method provides to the member a web link to the second fundraising group webpage. The member then may send a link to each potential contributor. A potential contributor will become a member of the second fundraising group by explicitly electing to become a member by affirming to such on the fundraising group webpage or implicitly becoming a member by taking another action, such as making a pledge donation or an actual donation. The method ends at 318.

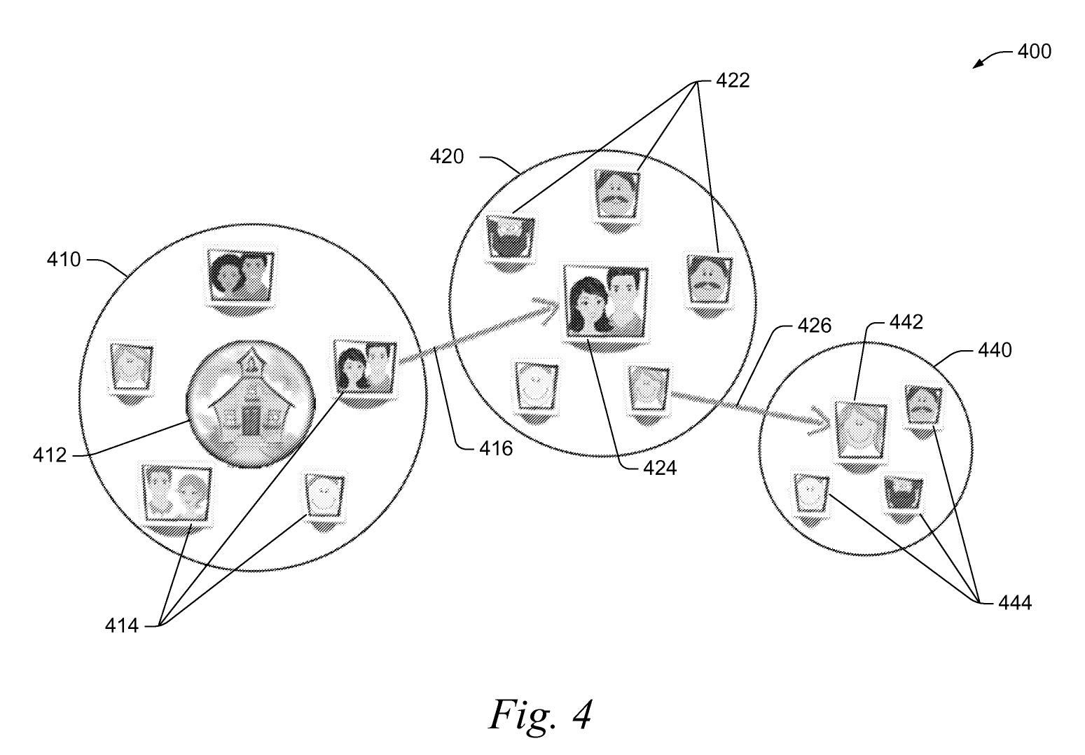

Referring to FIG. 4, a diagram 400 illustrating how Applicants' process makes use of social groups to increase donations for an exemplary fundraising scenario is depicted.

The first level group 410 (group n) comprises a coordinator 412 and a fundraising cause (not shown). In this exemplary fundraising scenario, the fundraising cause is the support of private school scholarships by making tax credit eligible donations to an STO. In some states, like Arizona, donations made to a Student Tuition Organization (“STO”) are eligible for a dollar-for-dollar state tax credit. STOs use the donations to grant scholarships to children attending private school. As such, the STO is the director of the fundraising cause and thereby the recipient of all contributions made in this exemplary fundraising scenario.

In this exemplary fundraising scenario, the coordinator 412 is a private school. The coordinator 412 invites the parents of the children enrolled in the school 414 (i.e., individuals in its social network) into the fundraising group 410. All donations by the parents 414, flow directly to the STO (not shown).

Each parent 414 may create their own fundraising group to support the fundraising cause. Line 416 represents the creation of one such new fundraising group 420 (group n+1). One of the parents 414 creates the new fundraising group 420 and becomes the coordinator 424. The fundraising cause of the new fundraising group 420 is identical to the original fundraising group 410.

The coordinator 424 invites his/her friends, family, and/or acquaintances 422 (i.e., individuals in his/her social network) into the fundraising group 420. Donations by the friends, family, and/or acquaintances 422, also flow directly to the STO (not shown).

Each friend, family, and/or acquaintance can each create their own fundraising group to support the fundraising cause. Line 426 represents the creation of one such new fundraising group 440 (group n+2) created by a friend, family, and/or acquaintance, who becomes the coordinator 442 of the new fundraising group 440. The fundraising cause of the new fundraising group 440 is identical to the original fundraising group 420 and 410.

The number of group levels can increase indefinitely (n+x) as long as group members continue to spawn new groups. Contributions from all groups (n to n+x) all flow to the director of the fundraising cause (in this case the STO).

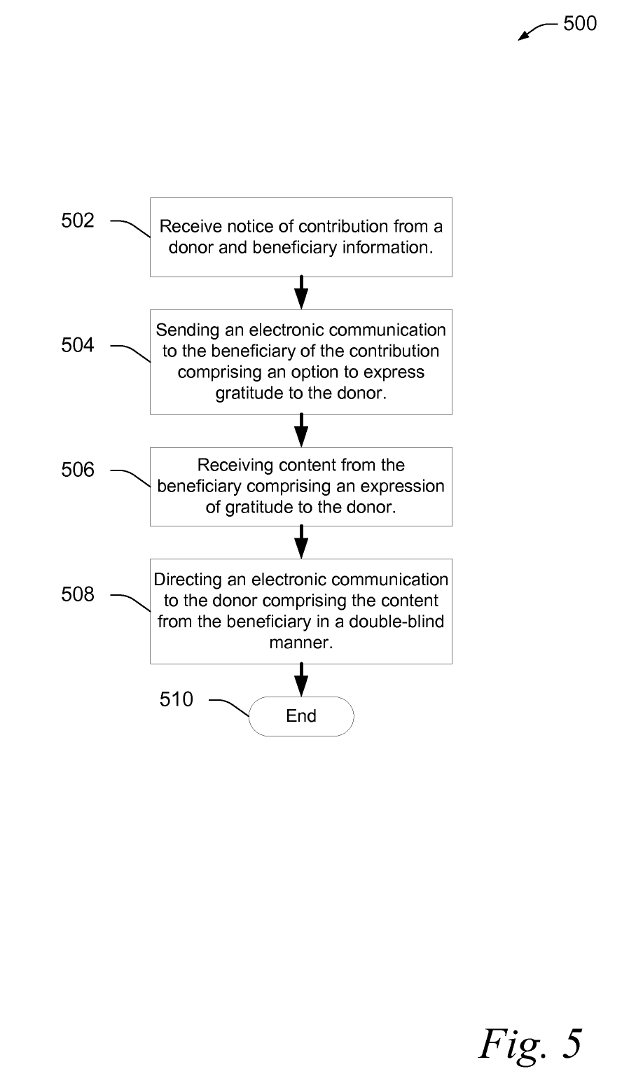

Referring to FIG. 5, a flowchart 500 of an exemplary computer implemented method for increasing fundraising collections through a double-blind communication system is depicted. This method enables the beneficiary of a donation made by a donor to express gratitude to the donor in a secure and anonymous manner. More specifically, the method allows communication between the donor and the beneficiary, in a manner that the identity of the beneficiary is not disclosed to the donor and such that the identity of the donor is not disclosed to the beneficiary (i.e., a “double-blind” communication system).

At step 502, the method receives a notice that a donor has made a contribution to a fundraising cause. In various embodiments, the notice is generated by the processing of an actual donation or received from the fundraising entity. In addition, the method receives beneficiary information, which includes for example, the email address or other contact information of the entity or individual who received a benefit made possible by the donation (i.e., the beneficiary).

At step 504, the method sends an electronic communication to the beneficiary of the contribution, including for example an email or other electronic communication. The electronic communication invites the beneficiary to provide content containing or representing an expression of gratitude for the donation. In one embodiment, the electronic communication does not in any way disclose, directly or indirectly, the identity of the donor. In different embodiments, the content includes a text, video, audio, picture, or a combination thereof. In various embodiments, the donor submits the content as a reply to the email or though a web form that was linked in the email.

At step 506, the method receives the content from the beneficiary. In one embodiment, the content is queued for manual review to ensure no personally identifiable information of the beneficiary is included.

At step 508, the method directs an electronic communication to the donor comprising the content from the beneficiary. In one embodiment, the electronic communication does not in any way disclose, directly or indirectly, the identity of the beneficiary, unless the beneficiary has provided content containing personally identifiable information and consented to the release of such information to the donor. In one embodiment, the electronic communication is an email message. The method ends at 510.

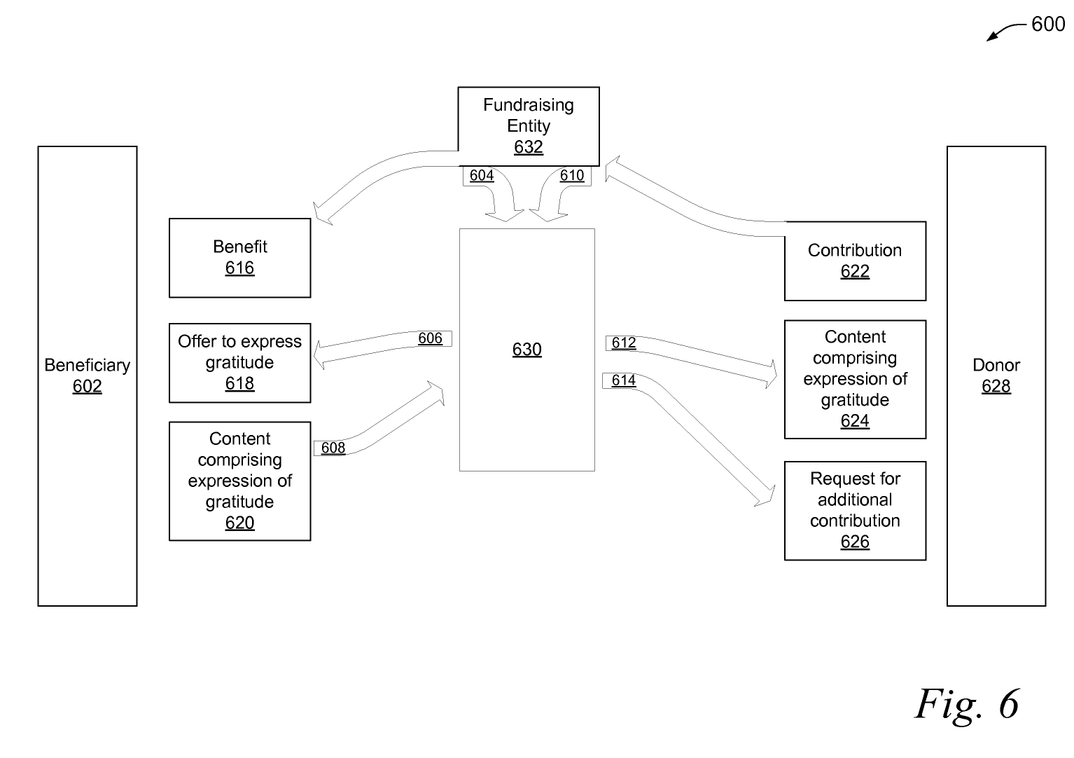

Referring to FIG. 6, a diagram 600 of the components of a double-blind communication system is depicted. A donor 628 makes a contribution 622 to a fundraising entity 632 using the Applicants' system 630. In the process of using the system 630 or making the contribution 622, the donor provides information 610. In one embodiment, the information 610 includes the donor's email address.

The contribution 622 is used to provide a benefit 616 to a beneficiary 602 through a fundraising entity 632. The fundraising entity 632 provides to the system 630 information 604 pertaining to the benefit 616 and the beneficiary 602. In various embodiments, the information 604 includes the identification and/or magnitude of the benefit 616 and/or the email address of the beneficiary 602. In one embodiment, the information 610 and 604 are provided through an email communication.

The system 630 sends a message 606 to the beneficiary 602 containing an invitation 618 to express gratitude to the donor 628 for the benefit 616. The message 606 does not include the identity or other personally identifiable information of the donor 628. In one embodiment, the message 606 is an email communication. In another embodiment, the message 606 is a letter sent through the postal system.

The beneficiary 602 sends a message 608 to the system 630 that provides content containing, or representing, an expression of gratitude 620 to the donor 628 for the benefit 616. In different embodiments, the message 608 contains text, photos, audio, video, or a combination thereof. In one embodiment, the message 608 is an email communication. In one embodiment, the message 608 is a letter sent though the postal system.

In one embodiment, the system 630 queues the message 608 for manual review to be inspected for personally identifiable information of the beneficiary. If any such information is found through manual inspection, the offending content is removed and/or modified, resulting in a modified message. In another embodiment, the message 608 is not queued for inspection or reviewed in any way.

The system 630 sends a message 612 to the donor that contains the expression of gratitude from the beneficiary 624. The expression of gratitude 624 comprises the content 620 provided by the beneficiary 602 (or in some embodiments, the content 620 that has been modified to remove personally identifiable information from the beneficiary 602). In one embodiment, the expression of gratitude 624 does not include the identity or other personally identifiable information of the beneficiary 602. In one embodiment, the message 612 is an email communication. In one embodiment, the message 612 is a letter sent by the postal system.

In some embodiments, the system 630 sends a message 614 comprising a request for an additional contribution 626 by the donor 628. In some embodiments, the request for an additional contribution 626 is included in the message 612.

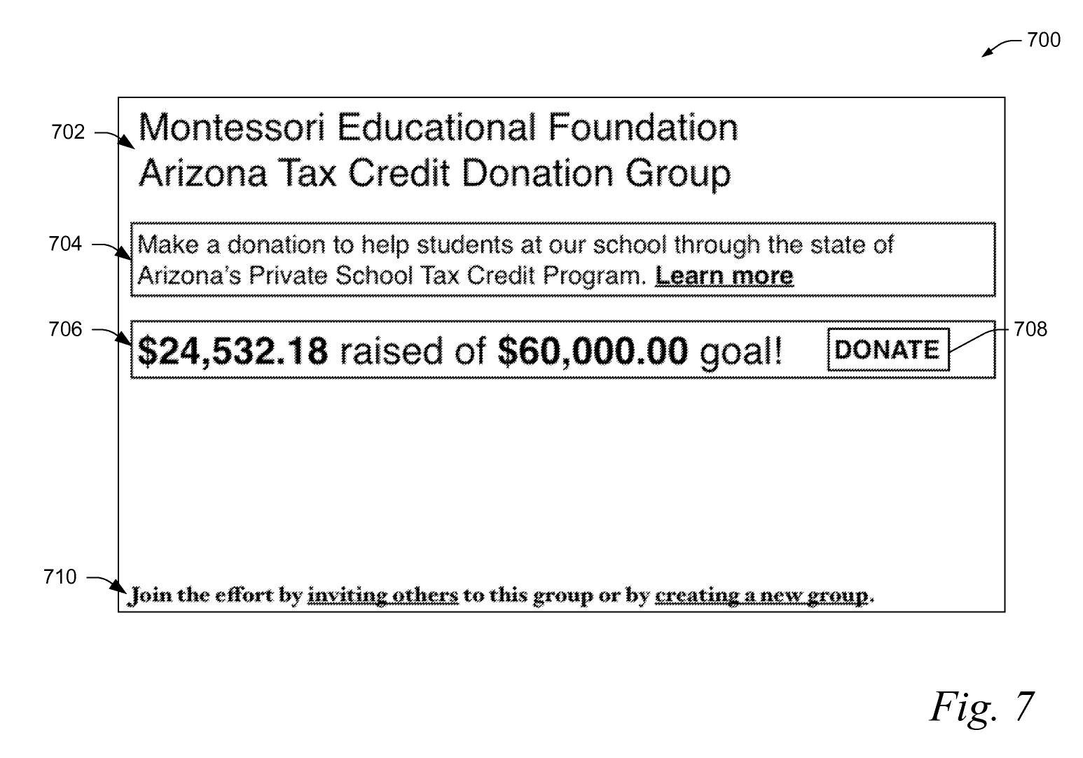

Referring to FIG. 7, an exemplary screenshot 700 of a user interface for a system to increase fundraising collections by leveraging social groups is depicted. The user interface 700 is for a Level 1 donation group. The name of the donation group 702 is included. In one embodiment, the name is provided by the coordinator of the group. Information pertaining to the fundraising cause 704 is also included. In one embodiment, the information 704 is provided by the director of the fundraising cause (in this case the STO) and/or by the coordinator. In some embodiments, the information 704 includes text, video, audio, animations, pictures, or a combination thereof.

Information pertaining to contribution activity 706 is also included. In some embodiments, the information 706 includes the total amount donated by the members of the group and the donation goal. In some embodiments, the information 706 includes the total amount pledged by members of the group and the pledge goal. In some embodiments, the information 706 includes the total amount pledged by members of the group, the donation goal, and the total amount donated.

In one embodiment, a donation button 708 is included. In one embodiment, a pledge button is included (not shown). In one embodiment, both a donation button 708 and a pledge button are included.

In one embodiment, an invitation 710 to invite others to the group or to create a new donation group is presented. This allows members to promote the fundraising cause in two different ways. The first, by inviting others to the group, grows the size of the existing group. The second, by creating a new group, adds an entirely new subgroup (level n+1) to promote the fundraising cause.

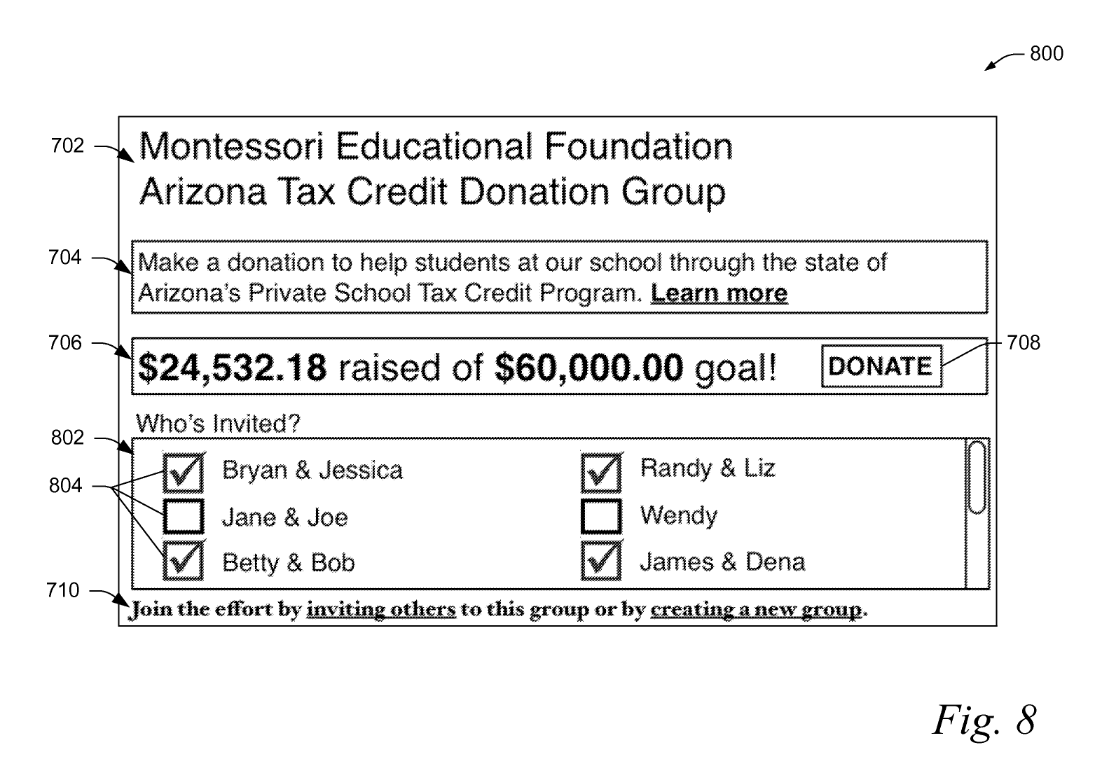

Referring to FIG. 8, another exemplary screenshot of a user interface for a system to increase fundraising collections by leveraging social groups is depicted. A participation section 802 is added to the embodiment of FIG. 7. In different embodiments, the participation section 802 includes a listing of the members of the group, a listing of the members who have made a pledge, a listing of the members who have made a donation, or a combination thereof. In one embodiment, the participation section 802 includes a listing of the members of the group and an indication of whether the member has made a donation or pledge (as indicated by the check boxes 804). In one embodiment, a check would indicate that the member has made a donation or pledge.

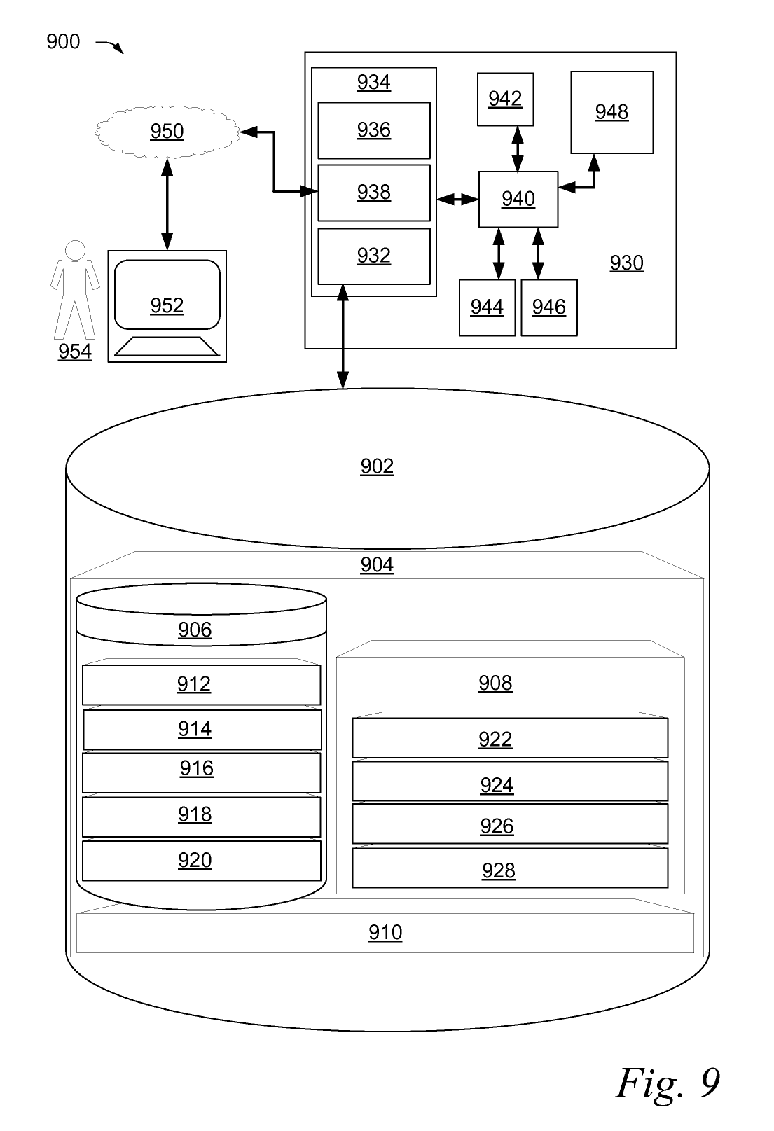

Referring to FIG. 9, a block diagram 900 illustrating embodiments of Applicants' system is depicted. A storage device 902 holds data to be used by the system. The storage 902 may comprise a hard drive or RAID array. The storage device 902 may be a single virtual system spread over a plurality of physical devices.

The components of Applicants' system may be embodied in a process component 904. In one embodiment, the process component 904 includes a database 906, application binaries 908, and an operating system 910. In various embodiments, the application binaries 908 include a donation engine, a communications engine, a donor feedback engine, a report engine, and a group engine.

In one embodiment, the database 906 comprises user accounts 912, group membership 914, group configuration data 916 (including any multimedia), donation and pledge activity 918, and content for initial and reminder communications 920. In various embodiments, the database 906 also comprises user account data and applications for charitable assistance.

In one embodiment, the application binaries 908 include a mail server 922, a web server 924, a database engine 926, and a payment processing engine 928.

In one embodiment, the different components 912-928 are spread across multiple physical storage devices. In one embodiment, the components 912-928 are hosted in a shared data storage or elastic cloud computing environment where the components 912-928 share physical hardware with other applications and where the presence of one or more components are allocated and deallocated across multiple physical systems as needed.

The storage device 902 is in communication with a computer device 930 through a storage interface 932. The storage interface 932 is part of the interface bus 934. The interface bus 934 also comprises an I/O interface 936 and a network interface 938.

A system bus 940 is in communication with the interface bus 934, a processor (i.e., a central processing unit or “CPU”) 942, random access memory (RAM) 944, read-only memory (ROM) 946, and a clock 948.

A computing device 952 is in communication with the network interface 938 through a communications network 950. In various embodiments, the computing device 952 is a desktop PC, a laptop, a tablet PC, a tablet device, a smart phone or other mobile device, or any other internet abled device. In various embodiments, the communication network is the internet, a local area network (LAN), a cellular network, a wireless network, or a combination thereof. A user 954 interacts with the system through the computing device 952.

In some embodiments, the computing device 930 is on a dedicated piece of hardware. In other embodiments, the computing device 930 is within a shared computing or elastic cloud computing environment where the resources are allocated and deallocated as necessary across one or more of a number of individual pieces of hardware.

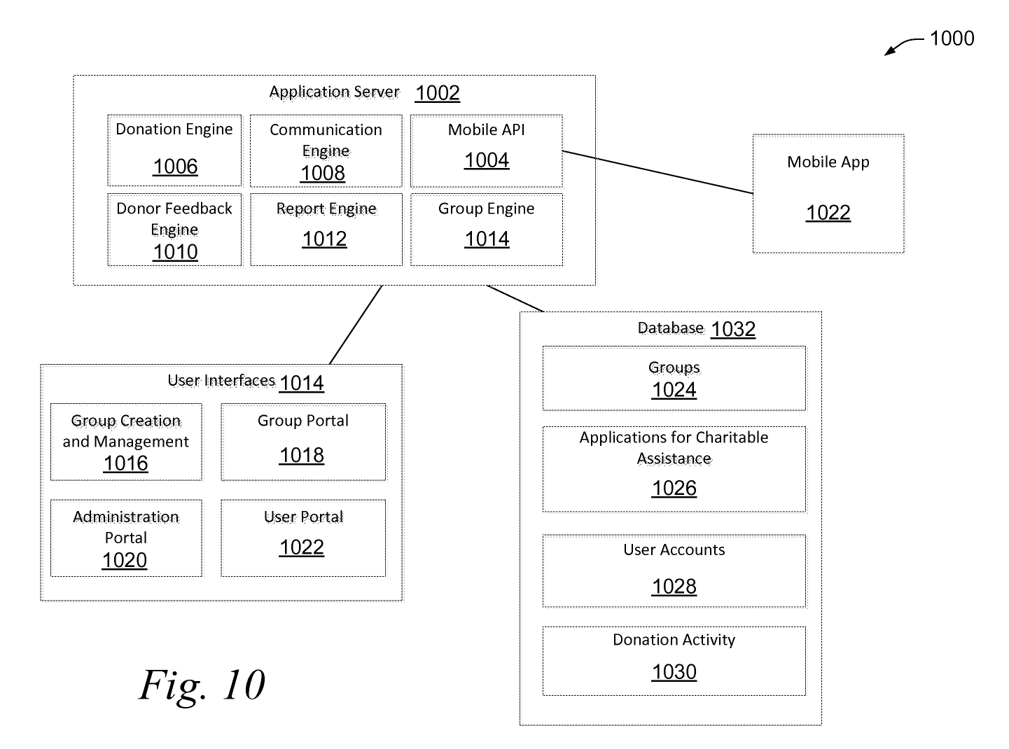

Referring to FIG. 10, a functional block diagram 1000 illustrating functional component embodiments of Applicants' system is depicted. An application server 1002 comprises a donation engine 1006, a communication engine 1008, a donor feedback engine 1010, a report engine 1012, a mobile API 1004, and a group engine 1014.

The group engine 1014 handles the organization independent groups (i.e., those not linked via subgroups) and the organization and relationship of related subgroups (i.e., groups related through different levels, n, n+1, n+2, etc.). The report engine 1012 handles the summarization of pledges, donations, and benefits given. The communication engine 1008 handles the timing and delivery of initial and reminder communications and other communications delivered by the system. The donor feedback engine 1010 handles the double-blind communication procedure (as described in FIGS. 5 & 6) to enable communication between the beneficiary and the donor. The mobile APIU1004 enables the features of the system to be made available via a mobile application 1022 running on a tablet, phone, or other internet-connected mobile device.

The database 1032 stores data necessary for operation of the system, including group information 1024, applications from potential beneficiaries for charitable assistance 1026, user accounts 1028, and donation and pledge activity 1030.

A user interacts with the system through one or more user interfaces (UIs) 1014. The different user interfaces 1014 comprise a group creation and management UI 1016, a group portal UI 1018, an administration portal UI 1020, and a user portal UI 1022. A user may be a coordinator or potential coordinator, a donor or potential donor, a pledgor or potential pledgor, a beneficiary or potential beneficiary, or a fundraising director or a potential fundraising director.

In one embodiment, at least one of the user interfaces 1014 is a web interface (i.e., the user interacts with the UI through a web browser). In one embodiment, at least one of the user interfaces 1014 is a mobile application (i.e., the user interacts with the UI by launching an application on a mobile device).

The group creation and management UI 1016 enables a coordinator to set up, configure, and manage a group. The group portal UI 1018 enables individuals to view group activity and/or make a donation or pledge. Examples of a group portal UI 1018 include FIGS. 7 & 8. The administration portal 1020 provides the fundraising director access to donation and pledge activity and other reports. The user portal 1022 enables the creation of a new group and/or allows individuals to complete an application for charitable assistance.

As would be appreciated by those of skill in the art, although some embodiments, examples, and/or figures herein pertain to donations made through an Arizona tax credit program, the methods and systems described herein could be applied to any fundraising effort.

A fundraising system has been described as including a processor controlled by instructions stored in a memory. The memory may be random access memory (RAM), read-only memory (ROM), flash memory or any other memory, or combination thereof, suitable for storing control software or other instructions and data. Some of the functions performed by the fundraising system have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of Applicants' fundraising system have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. In addition, disclosed aspects, or portions of these aspects, may be combined in ways not listed above. Accordingly, the invention should not be viewed as being limited to the disclosed embodiment(s).

What is claimed is:

1. A method of fundraising, comprising the processor implemented steps of:
receiving, from a first coordinator, contact information for each of a first set of potential contributors;
creating a first fundraising group, comprising a first group portal, wherein membership in the first fundraising group comprises said first set of potential contributors;
facilitating a payment of a contribution from at least one member of said first fundraising group to a fundraising entity;
receiving contact information for each of a second set of potential contributors, provided by:
a second coordinator, wherein said second coordinator is included in said first fundraising group; and/or
at least one of said second set of potential contributors in response to an invitation from said second coordinator;
creating a second fundraising group, comprising a second group portal, wherein membership in the second fundraising group comprises said second set of potential contributors; and
facilitating a payment of a contribution from at least one member of said second fundraising group to said fundraising entity.

2. The method of claim 1, further comprising sending an initial communication to each of said first fundraising group, wherein said initial communication includes a private link to said first group portal.

3. The method of claim 2, further comprising the processor implemented step of:
receiving content provided by said first coordinator, wherein said initial communication includes said content.

4. The method of claim 1, further comprising sending a reminder communication to each member of said first fundraising group who has not contributed and to each member of said second fundraising group who has not contributed.

5. The method of claim 4, further comprising:
receiving content provided by said fundraising entity, said first coordinator, said second coordinator, or a combination thereof, wherein said reminder communication includes said content.

6. The method of claim 1, wherein said first group portal includes contribution activity of said first fundraising group.

7. The method of claim 1, wherein said facilitating comprises:
receiving a pledge, comprising:
a pledge amount; and
a pledge date; and
processing said pledge on said pledge date.

8. The method of claim 1, wherein said facilitating comprises:
receiving reoccurring contribution instructions, comprising:
receiving a payment method;
receiving account information;
receiving payment frequency; and
receiving a total contribution amount; and
processing a portion of said total contribution amount on a reoccurring basis according to said payment frequency.

9. The method of claim 1, wherein said facilitating comprises:
receiving contribution instructions, comprising:
a payment method; and
account information; and
processing the contribution instructions.

10. The method of claim 1, further comprising the processor implemented steps of:
receiving content from a beneficiary of said fundraising entity, wherein said content includes an expression of gratitude for said contribution received from said member of said first or second fundraising group; and
sending said content to said member, wherein:
said contributor's identity is not disclosed to said beneficiary in any step of said method; and
said beneficiary's identity is not disclosed to said contributor in any step of said method.

11. A fundraising system, comprising:
a memory;
a processor in communication with said memory and configured to issue processing instructions stored in said memory to:
receive, from a first coordinator, contact information for each of a first set of potential contributors;
create a first fundraising group, comprising a first group portal, wherein membership in the first fundraising group comprises said first set of potential contributors;
facilitate a payment of a contribution from at least one member of said first fundraising group to a fundraising entity;
receive contact information for each of a second set of potential contributors, provided by:
a second coordinator, wherein said second coordinator is included in said first fundraising group; and/or
at least one of said second set of potential contributors in response to an invitation from said second coordinator;
create a second fundraising group, comprising a second group portal, wherein membership in the second fundraising group comprises said second set of potential contributors; and
facilitate a payment of a contribution from at least one member of said second fundraising group to said fundraising entity.

12. The system of claim 11, wherein said processor is further configured to issue processing instructions stored in said memory to send an initial communication to each of said first fundraising group, wherein said initial communication includes a private link to said first group portal.

13. The system of claim 12, wherein said processor is further configured to issue processing instructions stored in said memory to receive content provided by said first coordinator, wherein said initial communication includes said content.

14. The system of claim 11, wherein said processor is further configured to issue processing instructions stored in said memory to send a reminder communication to each member of said first fundraising group who has not contributed and to each member of said second fundraising group who has not contributed.

15. The system of claim 14, wherein said processor is further configured to issue processing instructions stored in said memory to receive content provided by said fundraising entity, said first coordinator, said second coordinator, or a combination thereof, wherein said reminder communication includes said content.

16. The system of claim 11, wherein said processor is further configured to issue processing instructions stored in said memory to display contribution activity of said first fundraising group in said first group portal.

17. The system of claim 11, wherein said processor is further configured to issue processing instructions stored in said memory to:
receive content from a beneficiary of said fundraising entity, wherein said content includes an expression of gratitude for said contribution received from said member of said first or second fundraising group; and
send said content to said member, wherein:
said contributor's identity is not disclosed to said beneficiary in any step of said method; and
said beneficiary's identity is not disclosed to said contributor in any step of said method.

18. A computer program for use on a computer system for social network-based fundraising, comprising:
a computer-readable medium on which are stored computer instructions such that, when said instructions are executed by a processor, said instructions cause the processor to:
receive, from a first coordinator, contact information for each of a first set of potential contributors;
create a first fundraising group, comprising a first group portal, wherein membership in the first fundraising group comprises said first set of potential contributors;
facilitate a payment of a contribution from at least one member of said first fundraising group to a fundraising entity;
receive contact information for each of a second set of potential contributors, provided by:
a second coordinator, wherein said second coordinator is included in said first fundraising group; and/or
at least one of said second set of potential contributors in response to an invitation from said second coordinator;
create a second fundraising group, comprising a second group portal, wherein membership in the second fundraising group comprises said second set of potential contributors; and
facilitate a payment of a contribution from at least one member of said second fundraising group to said fundraising entity.

19. The computer program of claim 18, wherein said instructions further cause the processor to send an initial communication to each of said first fundraising group, wherein said initial communication includes a private link to said first group portal.

20. The computer program of claim 18, wherein said instructions further cause the processor to:
receive content from a beneficiary of said fundraising entity, wherein said content includes an expression of gratitude for said contribution received from said member of said first or second fundraising group; and
send said content to said member, wherein:
said contributor's identity is not disclosed to said beneficiary in any step of said method; and
said beneficiary's identity is not disclosed to said contributor in any step of said method.
